(19) United States
(12) Patent Application Publication
(10) Pub. No.: US 2021/0044598 A1
(43) Pub. Date: Feb. 11, 2021

(54) SYSTEMS AND METHODS FOR SECURELY SHARING DATA SETS WITH ADJACENT ENTITIES

(71) Applicant: PC-TEL, Inc., Bloomingdale, IL (US)

(72) Inventors: Sumeet Singh Paul, Evanston, IL (US); Stephen V. Saliga, Akron, OH (US)

(21) Appl. No.: 16/989,220

(22) Filed: Aug. 10, 2020

Related U.S. Application Data
(60) Provisional application No. 62/884,752, filed on Aug. 9, 2019.

(51) Int. Cl. H04L 29/06; G06F 21/60; H04W 12/00

(52) U.S. Cl. CPC H04L 63/107; H04W 12/00503; H04L 63/0492; G06F 21/606

(57) ABSTRACT

Systems and methods for securely sharing data sets with adjacent entities are provided. Such systems and methods can include storing a data set associated with a first entity in a database device, each piece of the data set being related to a respective piece of geographic information, storing an identification of a sharing polygon with a second entity in the database device, the second entity being adjacent to the first entity, allowing the second entity access to each piece of the data set related to the respective piece of the geographic information that intersects with the sharing polygon, and restricting the second entity from accessing each piece of the data set related to the respective piece of the geographic information that fails to intersect with the sharing polygon.

### CROSS-REFERENCE TO RELATED APPLICATIONS

This application claims priority to U.S. Application No. 62/884,752 filed Aug. 9, 2020 and titled “SYSTEMS AND METHODS FOR SECURELY SHARING PERMIT OR INSPECTION RESULTS WITH ADJACENT MUNICIPALITIES.” U.S. Application No. 62/884,752 is hereby fully incorporated by reference as if set forth fully herein.

### FIELD

The present invention relates generally to data sets. More particularly, the present invention relates to systems and methods for securely sharing data sets with adjacent entities.

### BACKGROUND

Known systems and methods for storing and accessing permit and inspection results and submissions related to the permit and inspection results are stored at a municipality level and accessed through a manual filing system at a municipality office or through an online system dedicated to a single municipality. Accordingly, the permit and inspection results and the submissions related to the permit and inspection results are effectively restricted to employees or public servants of the single municipality. For example, when attempting to access a building report or inspection information for a structure located in Municipality 1, an individual, even if a civil servant from Municipality 2 and even if Municipality 2 is adjacent to Municipality 1, must manually request that data, for example, via email, fax, or mail, or physically travel to and visit the municipality office of Municipality 1 where the data is stored.

In view of the above, there is a continuing, ongoing need for improved systems and methods.

### BRIEF DESCRIPTION OF THE DRAWINGS

FIG. 1 is a block diagram of a system in accordance with disclosed embodiments;

FIG. 2A is a map of adjacent municipalities in accordance with disclosed embodiments; and

FIG. 2B is a map of adjacent municipalities in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods for securely sharing data sets with adjacent entities. It is to be understood that the data sets disclosed herein can include any type of data as would be known and desired by one of ordinary skill in the art and that the adjacent entities disclosed herein can include any type of entity as would be known and desired by one of ordinary skill in the art. For example, in some embodiments, the adjacent entities can include adjacent municipalities, and the data sets can include permit or inspection results, test data, or any other data defined by a first one of the adjacent municipalities for securely sharing with other ones of the adjacent municipalities. Similarly, in some embodiments, the adjacent entities can include carrier companies, and the data sets can include any type of RF signal data a first one of the carrier companies authorizes an operator of a base station transmitting or receiving the RF signal data to share with adjacent ones of the carrier companies.

In accordance with disclosed embodiments, systems and methods can store the data sets in a database that organizes, stores, and/or cross-references the data sets with geographic information for locations related to the data sets, for example, where the data sets were collected or where the data sets originated. In embodiments in which the data sets include the permit or inspection results and the adjacent entities include the adjacent municipalities, the geographic information can include a building address, a property identification number (PIN), a GPS location, a GPS index, a building diagram, a height of a building, and/or a municipality assignment. In this regard, is to be understood that the data sets can be related to any of a plurality of buildings, structures, or organizations within any of the municipalities. It is also to be understood that the database can segregate the data sets by information type (e.g. electrical permits and/or drawings, architectural drawings, public safety coverage reports).

In accordance with disclosed embodiments, the database can also store a list of geographic boundaries between all of the adjacent entities and authorized users associated with all of the adjacent entities. For example, in some embodiments, an administrative user of a first of the adjacent entities can define in the database a first set of the authorized users (e.g. municipal employees) with access to the data sets for the first of the adjacent entities and a second set of the authorized users with rights to share access to the data sets for the first of the adjacent entities with other ones of the adjacent entities. In these embodiments, the database can store lists of the first set of the authorized users and the second set of the authorized users, and an associated processor can restrict and allow access to and the rights to share the data sets for the first of the adjacent entities based on the first set of the authorized users and the second set of the authorized users as defined.

In some embodiments, the administrative user of the first of the adjacent entities can also define in the database a set of the geographic boundaries (e.g. a polygon) representing a border with a second of the adjacent entities and a width or depth of distance from the border for which the second of the adjacent entities can directly access the data sets for the first of the adjacent entities from the database. The database can store the set of the geographic boundaries and the width or depth of distance and, and the associated processor can restrict and allow access accordingly. For example, in embodiments in which the adjacent entities include the adjacent municipalities and the administrative user of a first of the adjacent municipalities identifies the width or depth of distance of 0.1 miles from the border between the first of the adjacent municipalities and a second of the adjacent municipalities, one of the authorized users from the second of the adjacent municipalities can directly access the data sets from the database for the locations in the first of the adjacent municipalities within 0.1 miles of the border between the first of the adjacent municipalities and the second of the adjacent municipalities. In this regard, it is to be understood that the administrative user of the first of the adjacent municipalities can define multiple sets of the geographic boundaries (e.g. multiple polygons) representing multiple borders with multiple ones of the adjacent municipalities, and in some embodiments, the multiple sets of the geographic boundaries and the multiple borders can be overlapping.

In some embodiments, the administrative user of the first of the adjacent entities can define in the database which of the adjacent entities can directly access the data sets for the first of the adjacent entities from the database and/or which of the authorized users associated with the adjacent entities can directly access the data sets for the first of the adjacent entities from the database. The database can store such definitions, and the associated processor can restrict and allow access accordingly.

In some embodiments, the associated processor can limit a direction of sharing information from the database. For example, when a sharer authorizes sharing sharer information with a sharee, the associated processor can allow the database to share the sharer information with the sharee. However, if a reciprocal relationship has not been defined, then the associated processor can prevent the database from sharing sharee information with the sharer. That is, the sharee must authorize sharing the sharee information with the sharer before the programmable processor will allow the database share the sharee information with the sharer.

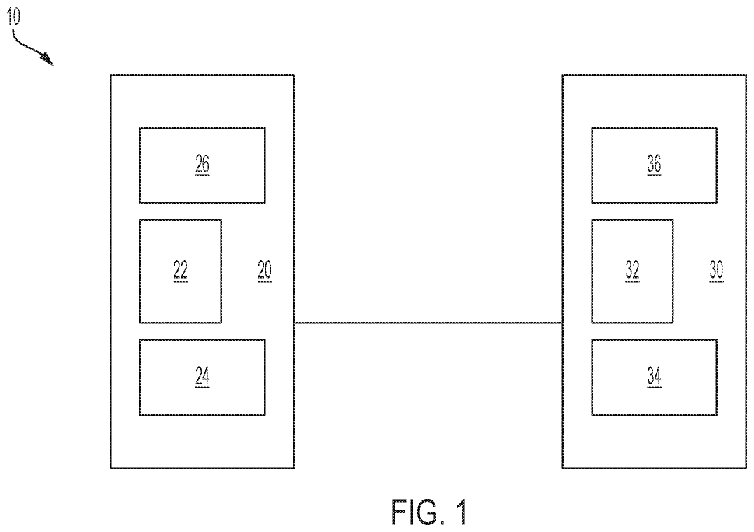

FIG. 1 is a block diagram of a system 10 in accordance with disclosed embodiments. As seen in FIG. 1, the system 10 can include a first server 20 associated with a first entity and a second server 20 associated with a second entity that is adjacent to the first entity. The first server 10 can include a first programmable processor 22, a first database 24 for storing first data sets associated with the first entity, and a first transceiver 26 for communicating with the second server 30, and the second server 30 can include a second programmable processor 32, a second database 34 for storing second data sets associated with the second entity, and a second transceiver 36 for communicating with the first server 20.

A first authorized user associated with the first entity can provide user input defining a first geographic boundary between the first entity and the second entity, and the first geographic boundary can include a first series of lines identifying a first border between the first entity and the second entity. For example, in some embodiments, the user input defining the first geographic boundary between the first entity and the second entity can include one or more of the first series of lines drawn on a map of the first and second entities. Similarly, the first authorized user can also provide user input defining a first identified distance from the first geographic boundary between the first entity and the second entity and into the first entity that is authorized for sharing. Then, the first database 24 can store definitions and/or identifications of the first geographic boundary between the first entity and the second entity and the first identified distance, and the first programmable processor 22 can use those definitions and/or identifications to generate a first sharing polygon reaching into the first entity that is authorized for sharing and that is defined by the first geographic boundary between the first entity and the second entity on one side and a first width therefrom equal to the first identified distance.

Additionally or alternatively, the first authorized user can provide user input drawing the first sharing polygon, for example, when the first sharing polygon has a large and/or irregular shape, and in these embodiments, the first database 24 can store the first sharing polygon as drawn.

In any embodiment, the first programmable processor 22 can use the first sharing polygon to restrict or allow access to the first data sets. For example, each piece of the first data sets can be associated with a respective piece of geographic information identifying a respective location related to that piece of the first data sets. As such, the first programmable processor 22 can restrict access to each piece of the first data sets associated with the respective piece of the geographic information identifying the respective location outside of the first sharing polygon, but allow the second server 30 access to each piece of the first data sets associated with the respective piece of the geographic information identifying the respective location inside of the first sharing polygon.

Similarly, a second authorized user associated with the second entity can provide user input defining a second geographic boundary between the first entity and the second entity, and the second geographic boundary can include a second series of lines identifying a second border between the first entity and the second entity. For example, in some embodiments, the user input defining the second geographic boundary between the first entity and the second entity can include one or more of the second series of lines drawn on the map of the first and second entities. Similarly, the first authorized user can also provide user input defining a second identified distance from the second geographic boundary between the first entity and the second entity and into the second entity that is authorized for sharing. Then, the second database 34 can store definitions and/or identifications of the second geographic boundary between the first entity and the second entity and the second identified distance, and the second programmable processor 32 can use those definitions and/or identifications to generate a second sharing polygon reaching into the second entity that is authorized for sharing and that is defined by the second geographic boundary between the first entity and the second entity on one side and a second width therefrom equal to the second identified distance.

Additionally or alternatively, the second authorized user can provide user input drawing the second sharing polygon, for example, when the second sharing polygon has a large and/or irregular shape, and in these embodiments, the second database 34 can store the second sharing polygon as drawn.

In any embodiment, the second programmable processor 32 can use the second sharing polygon to restrict or allow access to the second data sets. For example, each piece of the second data sets can be associated with the respective piece of the geographic information identifying the respective location related to that piece of the second data sets. As such, the second programmable processor 32 can restrict access to each piece of the second data sets associated with the respective piece of the geographic information identifying the respective location outside of the second sharing polygon, but allow the first server 20 access to each piece of the second data sets associated with the respective piece of the geographic information identifying the respective location inside of the second sharing polygon.

In accordance with the above, an ability to share the first data sets and the second data sets is optimized by applying rights to an intersection of location data instead of applying rights to individual locations. For example, the first programmable processor 22 can allow access to each piece of the first data sets based on an intersection of the respective piece of the geographic information with the first sharing polygon, and the second programmable processor 32 can allow access to each piece of the second data sets based on an intersection of the respective piece of the geographic information with the second sharing polygon. As such, in embodiments in which the adjacent entities include the adjacent municipalities, if a first building in a first of the adjacent municipalities (the first entity) encroaches into the first sharing polygon, then the first programmable processor 22 can allow access to all pieces of the first data sets associated with the first building. Similarly, if a second building in a second of the adjacent municipalities (the second entity) encroaches into the second sharing polygon, then the second programmable processor 32 can allow access to all pieces of the second data sets associated with the second building.

Advantageously, identifying and storing the first sharing polygon and the second sharing polygons at an entity level as described above can minimize efforts that would otherwise be required to construct a list of users authorized to access the first data sets and the second data sets, thereby eliminating several calculation steps. Instead, systems and methods disclosed herein can simply identify the respective piece of the geographic information associated with each piece of the first data sets and the second data sets that intersects with the first sharing polygon or the second sharing polygon and allow access to those pieces of the first data sets and the second data sets.

Although not shown in FIG. 1, it is to be understood that the system 10 can also include a global server associated with the first entity and the second entity that includes a global programmable processor, a global database for storing some or all of the above-identified information stored by the first database 24 and the second database 34, and a global transceiver for communicating with the first server 20 and the second server 30. In some embodiments, the global database can store all of the first data sets, all of the second data sets, and identifications of the first sharing polygon and the second sharing polygon received from the first server 20 and the second server 30, and in these embodiments, the global programmable processor can use the first sharing polygon to restrict or allow access to the first data sets as described above and use the second sharing polygon to restrict or allow access to the second data sets as described above. However, in some embodiments, the global database can store only those pieces of the first data sets associated with the respective piece of the geographic information identifying the respective location inside of the first sharing polygon that is shared thereto by the first server 20 and only those pieces of the second data sets associated with the respective piece of the geographic information identifying the respective location inside of the second sharing polygon shared thereto by the second server 30, and in these embodiments, the global programmable processor can allow access to any pieces of the first data sets and any pieces of the second data sets stored in the global database because a determination as to restricting or allowing such access will have already been made by the first server 20 or the second server 30.

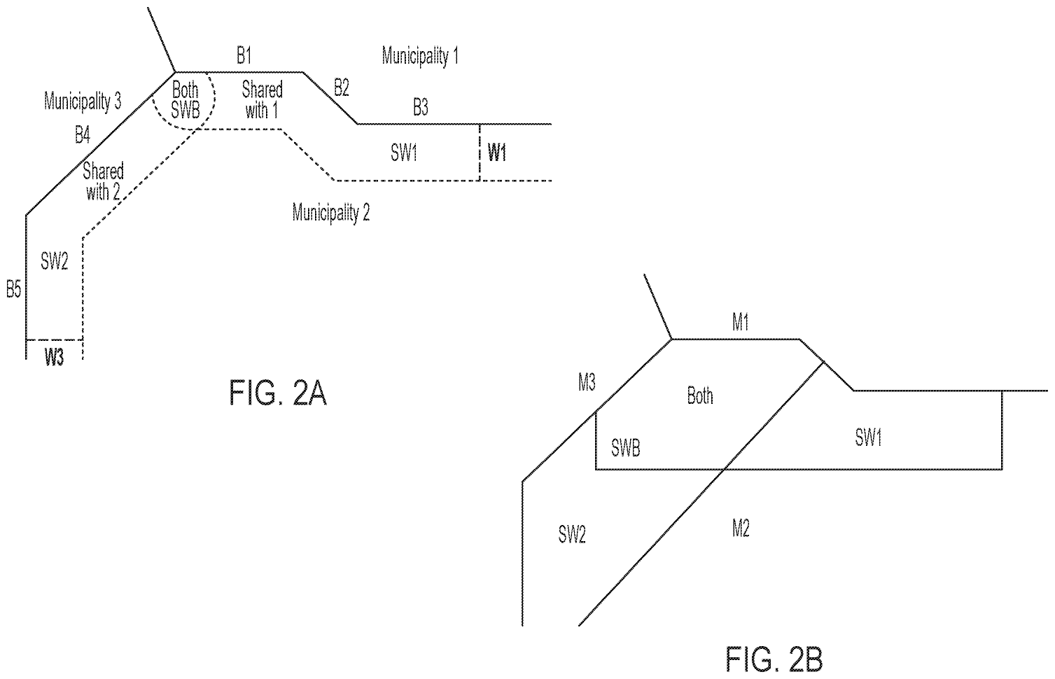

A specific, but non-limiting example of systems and methods disclosed herein in which the adjacent entities include the adjacent municipalities can be illustrated with the maps seen in FIG. 2A and FIG. 2B.

As seen in FIG. 2A, in some embodiments, some user associated with Municipality 2 M2 can provide user input defining a geographic boundary between Municipality 2 M2 and Municipality 1 M1, including a series of lines B1, B2, B3 identifying a border between Municipality 2 M2 and Municipality 1 M1, and identifying an distance W1 from the geographic boundary between Municipality 2 M2 and Municipality 1 M1 and into Municipality M2 that is authorized for sharing, thereby defining a first sharing polygon SW1 reaching into Municipality 2 M2 that is authorized for sharing with Municipality 1 M1. That user associated with Municipality 2 M2 can also provide user input defining a geographic boundary between Municipality 2 M2 and Municipality 3 M3, including a series of lines B4, B5 identifying a border between Municipality 2 M2 and Municipality 3 M3, and identifying a distance W2 from the geographic boundary between Municipality 2 M2 and Municipality 3 M3 and into Municipality 2 M2 that is authorized for sharing, thereby defining a second sharing polygon SW2 reaching into Municipality 2 M2 that is authorized for sharing with Municipality 3 M3.

However, as seen in FIG. 2B, in some embodiments, some user associated with Municipality 2 M2 can provide user input drawing the first sharing polygon SW1 reaching into Municipality 2 M2 that is authorized for sharing with Municipality 1 M1. That user associated with Municipality 2 M2 can also provide user input drawing a second sharing polygon SW2 reaching into Municipality 2 M2 that is authorized for sharing with Municipality 3 M3.

As seen in both FIG. 2A and FIG. 2B, in some embodiments, a portion of the first sharing polygon SW1 can overlap with a portion of the second sharing polygon SW2, thereby defining a third sharing polygon SWB reaching into the Municipality 2 M2 that is authorized for sharing with both Municipality M1 and Municipality 3 M3.

Although a few embodiments have been described in detail above, other modifications are possible. For example, other components may be added to or removed from the described systems, and other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
storing a data set associated with a first entity in a database device, each piece of the data set being related to a respective piece of geographic information;
storing an identification of a sharing polygon with a second entity in the database device, the second entity being adjacent to the first entity;
allowing the second entity access to each piece of the data set related to the respective piece of the geographic information that intersects with the sharing polygon; and
restricting the second entity from accessing each piece of the data set related to the respective piece of the geographic information that fails to intersect with the sharing polygon.

2. The method of claim 1 wherein the first entity includes a first municipality, and wherein the second entity includes a second municipality.

3. The method of claim 2 wherein the data set includes permit or inspection results.

4. The method of claim 2 further comprising:
when the respective piece of the geographic information related to any part of a building located in the first municipality intersects with any part of the sharing polygon, allowing the second entity access to all pieces of the data set for the building.

5. The method of claim 1 wherein the respective piece of the geographic information related to each piece of the data set identifies where a respective piece of the data set was collected or originated.

6. The method of claim 1 wherein the respective piece of the geographic information related to each piece of the data set identifies a respective location related to a respective piece of the data set, and wherein the respective piece of the geographic information related to each piece of the data set intersects with the sharing polygon when the respective location related to the respective piece of the data set is inside of the sharing polygon.

7. The method of claim 1 further comprising:
storing an identification of a geographic boundary representing a border between the first entity and the second entity;
storing an identification of a distance from the border into the first entity; and
using the geographic boundary and the distance to identify the sharing polygon.

8. The method of claim 1 further comprising:
storing the data set and storing the identification of the sharing polygon at an entity level.

9. The method of claim 1 wherein the first entity includes a first carrier company, and wherein the second entity includes a second carrier company.

10. The method of claim 9 wherein the data set includes RF signal data transmitted or received by a base station.

11. A system comprising:
a programmable processor; and
a database,
wherein the database stores a data set associated with a first entity,
wherein each piece of the data set is related to a respective piece of geographic information,
wherein the database stores an identification of a sharing polygon with a second entity,
wherein the second entity is adjacent to the first entity,
wherein the programmable processor allows the second entity access to each piece of the data set related to the respective piece of the geographic information that intersects with the sharing polygon, and
wherein the programmable processor restricts the second entity from accessing each piece of the data set related to the respective piece of the geographic information that fails to intersect with the sharing polygon.

12. The system of claim 11 wherein the first entity includes a first municipality, and wherein the second entity includes a second municipality.

13. The system of claim 12 wherein the data set includes permit or inspection results.

14. The system of claim 12 wherein, when the respective piece of the geographic information related to any part of a building located in the first municipality intersects with any part of the sharing polygon, the programmable processor allows the second entity access to all pieces of the data set for the building.

15. The system of claim 11 wherein the respective piece of the geographic information related to each piece of the data set identifies where a respective piece of the data set was collected or originated.

16. The system of claim 11 wherein the respective piece of the geographic information related to each piece of the data set identifies a respective location related to a respective piece of the data set, and wherein the respective piece of the geographic information related to each piece of the data set intersects with the sharing polygon when the respective location related to the respective piece of the data set is inside of the sharing polygon.

17. The system of claim 11 wherein the database stores an identification of a geographic boundary representing a border between the first entity and the second entity, wherein the database device stores an identification of a distance from the border into the first entity, and wherein the programmable processor uses the geographic boundary and the distance to identify the sharing polygon.

18. The system of claim 11 wherein the database stores the data set and the identification of the sharing polygon at an entity level.

19. The system of claim 11 wherein the first entity includes a first carrier company, and wherein the second entity includes a second carrier company.

20. The system of claim 19 wherein the data set includes RF signal data transmitted or received by a base station.
